(19) United States
(12) Patent Application Publication
(10) Pub. No.: US 2022/0018465 A1
(43) Pub. Date: Jan. 20, 2022

(54) A SAVER SUB FOR A CONNECTION SYSTEM AND A METHOD OF INSTALLING SUCH A SAVER SUB

(71) Applicant: Vetco Gray Scandinavia AS, Nailsea (GB)

(72) Inventor: Rolf BASTESEN, Sandvika (NO)

(21) Appl. No.: 17/295,340

(22) PCT Filed: Nov. 26, 2019
(86) PCT No.: PCT/EP2019/025419

§ 371 Date: May 19, 2021

(30) Foreign Application Priority Data
Nov. 28, 2018 (NO) 20181542

(51) Int. Cl. F16L 1/26; F16L 23/00

(52) U.S. Cl. CPC F16L 1/26; F16L 55/46; F16L 23/006

(57) ABSTRACT

The present invention relates to a subsea fluid flow tubular connection system with an inboard hub in fluid connection with piping of a sub sea hydrocarbon exploration or production system and an outboard hub. The sub sea fluid flow tubular connection system comprise a tubular saver sub with an inboard hub connecting portion in sealing contact with the inboard hub at a first end and an outboard hub connecting portion in sealing contact with the outboard hub at a second end. A method of installing and exchanging such a tubular saver sub is also disclosed.

The present invention relates to a saver sub for a connection system and a method of installing such a saver sub.

A saver sub of the present invention may be used as an easily exchanged wearing part in a connection system where the connection is planned to be broken and remade several times. An example of such a connection is a pig launcher or receiver connected to perform a pigging operation and disconnected and recovered until the next pigging. A blind cap is normally deployed and connected to contain the second barrier to the produced hydrocarbons after recovery. In some cases, the produced fluid or gas may have a composition resulting in faster deposition of layers on the internal pipe wall that will restrict the flowrate. In this case, a high frequency of the pigging operations must be planned for which may arise concern to what extend the inboard (IB) hub may be worn and in time could affect the pressure integrity once the connection is made up. The IB flange (or hub) is welded to the piping system contained at the seabed installed structure and is as such not easily recovered. The welded hub must be cut off and replaced with a new hub, involving extensive work and subsequent retesting to qualify pressure integrity before reinstallation subsea. This situation may call for an easily replaceable IB hub—a saver sub.

The present invention simplify hub replacement incorporating a minimum saver sub spool piece to the standard (or minimum modified) connection system to recover the worn saver sub with the recovery of for instance a PLR (pig launcher/receiver) and then reinstall a replacement saver sub with the later.

The invention will eliminate development of a saver sub interfacing the front and rear of an IB connection in addition to the required running tool with stroking functionality. It will also reduce offshore time and cost associated with recovery and re-installation.

The present invention relates to a subsea fluid flow tubular connection system with an inboard hub in fluid connection with piping of a subsea hydrocarbon exploration or production system and an outboard hub. The subsea fluid flow tubular connection system comprise a tubular saver sub with an inboard hub connecting portion in sealing contact with the inboard hub at a first end and an outboard hub connecting portion in sealing contact with the outboard hub at a second end.

The inboard hub is typically connected to installed subsea equipment and the outboard hub is typically connected to an element to be connected to the hub of the installed subsea equipment

The tubular saver sub may have an outer diameter greater than a length between the inboard hub connecting portion and the outboard hub connecting portion.

The tubular saver sub may be connected to the inboard hub at the first end with an inboard hub clamp and to the outboard hub at the second end with an outboard hub clamp.

The subsea fluid flow tubular connection system may further include a guiding and alignment system. The guiding and alignment system includes at least one inboard guide with a fixed position in relation to the inboard hub and an outboard guide for each of the least at least one inboard guide with a fixed position in relation to the outboard hub and in guiding cooperation with the at least one inboard guide. A space is allowed by the at least one inboard guide and the outboard guide for each of the least at least one inboard guide between an end of the inboard hub and an end of the outboard hub to allow room for the tubular saver sub.

Furthermore, the invention relates to a method of installing of a cylindrical saver sub of a subsea fluid flow tubular connection system to installed subsea equipment comprises installing the cylindrical saver sub to a hub of an element to be connected to a hub of the installed subsea equipment. The cylindrical saver sub is lowered on the hub of the element to be connected to the hub of the installed subsea equipment. The cylindrical saver sub is connected to the hub of the installed subsea equipment.

Furthermore, the invention relates to a method of exchanging of a worn cylindrical saver sub of a subsea fluid flow tubular connection system with a replacement cylindrical saver sub. The method comprises releasing the worn saver sub from a hub of installed subsea equipment, retrieving an element to be released from the hub of installed subsea equipment along with the worn saver sub, installing a replacement saver sub to the retrieved element, lowering the replacement saver sub on retrieved element and connecting the replacement saver sub to hub to the installed subsea equipment.

Detailed description of an embodiment of the invention with reference to the enclosed figures:

All the figures in the following disclosure show the same embodiment and similar reference numerals refers to similar parts on all the figures.

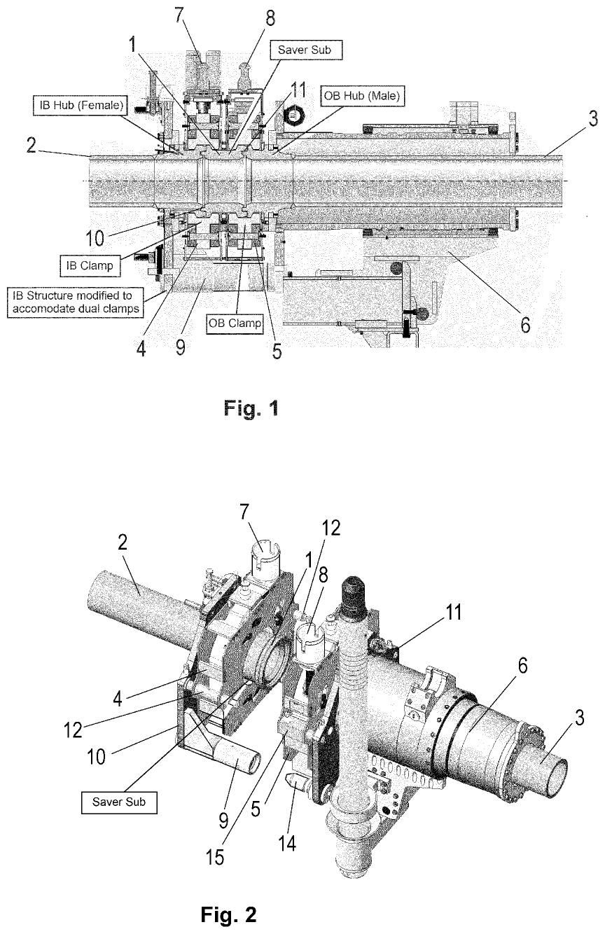

FIG. 1 is a cross section of a traditional subsea fluid flow connection system with a saver sub 1 of the invention. The saver sub 1 may be considered as a spool piece.

Such systems are utilized for subsea hydrocarbon exploration and production and conveys produced fluid, fluid for injection into wells etc. The saver sub includes a tubular section with an inner cylindrical portion and an outer cylindrical portion between a male hub 10 at a first end and a female hub 11 at a second end. The male and female portion of the saver sub or saver spool piece 1 are complementary to allow the saver sub or saver spool piece 1 to be omitted. The saver hub is a short hub, typically with a length less than the outer diameter of the outer cylindrical portion. The saver sub is connected to an inboard (IB) hub 2 of installed subsea equipment and an outboard (OB) hub 3 of temporarily installed retrievable subsea equipment. The inboard hub 2 is a part of a retrievable element in the form of a pig launcher/pig receiver 6. The male hub 10 of the saver sub 1 is fixed to the female IB hub 2 with an IB hub clamp 4 with a IB tool bucket 7 for a ROV tool. The female hub 11 of the saver sub 1 is fixed to the male OB hub 3 with an OB hub clamp 5 with a tool bucket 8 for a ROV tool. A guiding and alignment system 9 is modified to accommodate the additional length of the connection with the saver sub 1.

FIG. 2 is a perspective view of the traditional subsea connection system with the saver sub 1 of the invention, shown in a disconnected state. The traditional subsea connection system with the added saver sub 1 is disconnected at the OB end of the saver sub. The IB hub clamp 4 with the IB tool bucket 7 is fixed to the IB hub 2 and the IB end of the saver sub and remains normally closed and clamped even during connection and disconnection of the subsea connection system. The IB hub clamp 4 is only released when the saver sub 1 is worn out or damaged and is exchanged.

The OB hub clamp 5 with the OB tool bucket 8 is fixed to the OB hub 3 and the OB end of the saver sub and is closed and opened during connection and disconnection of the subsea connection system. The modified and extended guiding and alignment system 9 accommodating the additional length of the connection with the saver sub 1 extend from an IB fixing plate 10 on the IB hub 2 and from an OB fixing plate 11 on the OB hub 3. The guiding and alignment system 9, 14 is typically extended the same amount as the length of the saver sub 1. Additional tension locking members 12, 15 extended to accommodate the additional length of the connection with the saver sub 1 extend from the IB fixing plate 10 on the IB hub 2 and the OB fixing plate 11 on the OB hub 3.

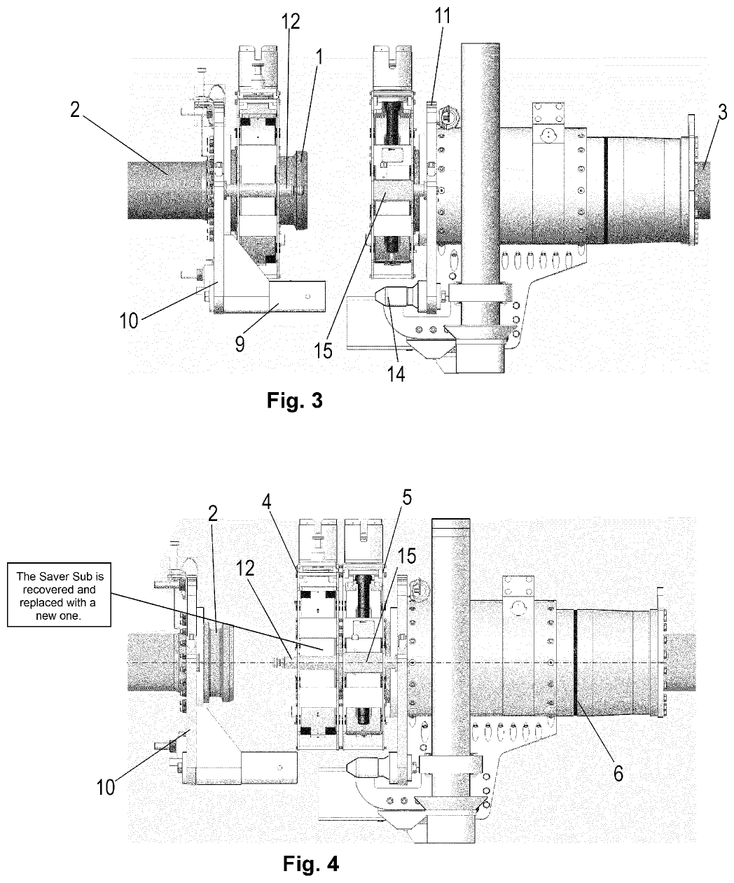

FIG. 3 is a side elevation of the connection system with the saver sub 1 of the invention. The IB fixing plate 10 secures the IB portion of the alignment system 9 and the IB portion of the additional tension locking members 12. The OB fixing plate 11 secures the OB portion of the alignment system 14 and the OB portion of the additional tension locking members 15.

FIG. 3 shows the normal state of the connection system with the saver hub semi permanently fixed to the IB hub 2.

FIG. 4 corresponds to FIG. 3 apart from showing the saver sub and the IB hub clamp 4 fixed to the OB hub and the OB hub clamp 5. The IB hub 2 is exposed and the additional tension locking members 12, 15 are released from the IB fixing plate 10.

FIG. 4 shows the configuration of the invention before installation or removal of the saver sub. FIG. 4 shows that the saver sub can be installed or removed without any additional tools or steps beyond the steps required for installing or removing the pig launcher/pig receiver 6. The pig launcher/pig receiver 6 is typically exchanged with a blind plug/blind cap when the pig launcher/pig receiver 6 not is used.

The IB hub 2 typically forms a part of a manifold and is in fluid connection with an export pipe. The OB hub 3 is shown connected to a pig launcher/pig receiver 6, but could be connected to other types of equipment that are connected and disconnected multiple times such as choke modules and return jumpers. The OB hub 3 is typically sealed with a blind cap when the OB hub 3 not is connected to the pig launcher/pig receiver 6 or to other types of equipment.

A method for installation of a saver sub includes installing a saver sub to an OB hub of an element that shall be connected to the IB hub of installed subsea equipment, lowering the saver sub on the OB hub of the element that shall be connected to the IB hub, and connecting the saver sub to the IB hub.

A method for exchange of a used saver sub includes releasing the saver sub from an IB hub of the installed subsea equipment, retrieving the element that shall be released from to the IB hub along with the used saver sub, installing a new saver sub to an OB hub of an element that shall be connected to the IB hub of the installed subsea equipment, lowering the new saver sub on the OB hub of the element that shall be connected to the IB hub, and connecting the new saver sub to the IB hub.

1. A subsea fluid flow tubular connection system with an inboard hub in fluid connection with piping of a subsea hydrocarbon exploration or production system and an outboard hub, the subsea fluid flow tubular connection system comprising a tubular saver sub with an inboard hub connecting portion in sealing contact with the inboard hub at a first end and an outboard hub connecting portion in sealing contact with the outboard hub at a second end.

2. The subsea fluid flow tubular connection system of claim 1, wherein the tubular saver sub has an outer diameter greater than a length between the inboard hub connecting portion and the outboard hub connecting portion.

3. The subsea fluid flow tubular connection system of claim 1, wherein the tubular saver sub is connected to the inboard hub at the first end with an inboard hub clamp and to the outboard hub at the second end with an outboard hub clamp.

4. The subsea fluid flow tubular connection system of claim 1, further comprising a guiding and alignment system with at least one inboard guide with a fixed position in relation to the inboard hub and an outboard guide for each of the least at least one inboard guide with a fixed position in relation to the outboard hub and in guiding cooperation with the at least one inboard guide, wherein a space allowed by the at least one inboard guide and the outboard guide for each of the least at least one inboard guide is formed between an end of the inboard hub and an end of the outboard hub to allow room for the tubular saver sub.

5. A method of installing of a cylindrical saver sub of a subsea fluid flow tubular connection system to installed subsea equipment comprising:
installing the cylindrical saver sub to a hub of an element to be connected to a hub of the installed subsea equipment;
lowering the cylindrical saver sub on the hub of the element to be connected to the hub of the installed subsea equipment; and connecting the cylindrical saver sub to the hub of the installed subsea equipment.

6. A method of exchanging of a worn cylindrical saver sub of a subsea fluid flow tubular connection system with a replacement cylindrical saver sub comprising:
releasing the worn saver sub from a hub of installed subsea equipment;
retrieving an element to be released from the hub of installed subsea equipment along with the worn saver sub;
installing a replacement saver sub to the retrieved element;
lowering the replacement saver sub on the retrieved element; and
connecting the replacement saver sub to hub to the installed subsea equipment.
